(19) United States
(12) Patent Application Publication
(10) Pub. No.: US 2025/0216099 A1
(43) Pub. Date: Jul. 3, 2025

(54) INLINE AIR PURIFICATION SYSTEM AND METHOD

(71) Applicant: Vibrant Building Technologies LLC, Norwalk, CT (US)

(72) Inventor: Ryan Anderson FLETCHER, Redding, CT (US)

(21) Appl. No.: 18/400,865

(22) Filed: Dec. 29, 2023

(51) Int. Cl. F24F 7/08; F24F 11/64; F24F 13/28; F24F 110/65

(52) U.S. Cl. CPC F24F 7/08; F24F 11/64; F24F 13/28; F24F 2110/65

(57) ABSTRACT

Embodiments herein describe a method including using one or more air quality sensors and an air purifier to detect and adjust air quality within a structure having a heating, ventilation, and air conditioning (HVAC) system, the air purifier having a first variable speed fan in an intake channel and a second variable speed fan in an exhaust channel, and, in response to detecting an adverse air quality event within the building envelope by one or more sensors, automatically adjusting a speed of the first variable speed fan and a speed of the second variable speed fan (i) to maintain an air flow ratio between air inflow and air outflow within the HVAC system, (ii) to introduce increased fresh and filtered air flow from outside, (iii) to increase filtration of indoor air, (iv) to monitor the ERV and filter performance, and (v) to send relevant maintenance notifications to the user.

### TECHNICAL FIELD

Examples of the present disclosure generally relate to an inline air purification system and method.

### BACKGROUND

A heating, ventilation, and air conditioning (HVAC) system may be used to thermally regulate and condition an environment, such as a building, home, or other structure. The HVAC system may include a direct expansion cooling and conditioning system, which has heat exchangers such as a condenser and an evaporator, which transfer thermal energy between the HVAC system and the environment. In many cases, the HVAC system may be used to direct a continuous flow of fresh outdoor air into a building to provide ventilation and improved air quality within the building. The outdoor air may be conditioned prior to entering the building by mixing the return air and flowing across a heat exchange area of the evaporator, which absorbs thermal energy from the mixed flow. Accordingly, ductwork extending throughout the building may supply the conditioned air to various rooms or zones of the building.

An air purifier may be configured to purify air within a space. As air moves through a filter of the purifier, pollutants, pollen, airborne microbes, pet dander, and particles such as dust, smoke, or the like, may be captured in the filter, and neutralized. The filtered air may be recirculated into the space. In some cases, air purifiers may be configured to diagnose and report pollutants or unbalanced gas mixes in real-time, such as by using an air quality sensor embedded within the air purifier. The air purifier may be further comprised of elements that facilitate ventilation of stale indoor air and exchange with fresh outside air. This ventilation may further take the form of an energy recovery ventilator (ERV) or heat recovery ventilator (HRV) to transfer heat (ERV and HRV) and humidity (ERV only) between the fresh and stale air. The ventilation may serve to remove harmful gases from the building envelope, which pass through the purifier's filters uncaptured and would otherwise recirculate within the building.

However, in most systems, these two elements, that is, the HVAC and air purifier, are not designed to work together, and, thus, there is still a need for an air purifying device that works in cooperation with an HVAC system to remove airborne contaminant particles and gases within a building, home or other structure.

### SUMMARY

One embodiment described herein is a method for using one or more air quality sensors and an air purifier to detect and adjust air quality within a structure having a heating, ventilation, and air conditioning (HVAC) system, the air purifier having a first variable speed fan in an intake channel and a second variable speed fan in an exhaust channel, and, in response to detecting an adverse air quality event within the structure by one or more sensors, automatically adjusting a speed of the first variable speed fan and a speed of the second variable speed fan (i) to maintain an air flow ratio between air inflow and air outflow within the HVAC system to ensure air pressure within the building envelope is balanced, (ii) to introduce increased fresh and filtered air flow from outside the building envelope, and (iii) to control filtration of indoor air.

One embodiment described herein is a method for purifying air within a structure, the method including detecting negative air pressure within the building envelope caused by, for example, bathroom exhaust fans, kitchen hoods or any system that exhausts air from the envelope by using an air purifier having a first variable speed fan in an intake channel and a second variable speed fan in an exhaust channel, and introducing increased fresh air flow from outside the building envelope by automatically adjusting the speed of the first variable speed fan.

One embodiment described herein is an air purification system for a building, the air purification system including a housing including at least an ERV or HRV, an ionization filter, an Ultraviolet-C (UVC) light, and an intake channel connected to the housing, wherein a first variable speed fan is located in the intake channel and an exhaust channel connected to the housing, wherein a second variable speed fan is located in the exhaust channel. When an adverse air quality event is detected within the building, a speed of the first variable speed fan is automatically adjusted by a central processing unit (CPU) (i) to maintain an air flow ratio between air inflow and air outflow within a heating, ventilation, and air conditioning (HVAC) system to ensure air pressure within the building is balanced, (ii) to introduce increased fresh and filtered air flow from outside the building, and (iii) to increase filtration of indoor air.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates a perspective view of an inline system including an air purification system integrated with a heating, ventilation, and air conditioning (HVAC) system, according to an example.

FIG. 2 is a schematic view of the air purification system integrated with the HVAC system, according to an example.

FIG. 3 illustrates a first screenshot on a graphical user interface (GUI) depicting air quality within rooms of a house, according to an example.

FIG. 4 illustrates a second screenshot on the GUI depicting air purification system connections to rooms of a house, according to an example.

FIG. 5 illustrates a method for purifying air within a house, according to an example.

FIG. 6 illustrates a first sensor scenario, according to an example.

FIG. 7 illustrates a second sensor scenario, according to an example.

FIG. 8 illustrates a third sensor scenario, according to an example.

FIG. 9 illustrates a fourth sensor scenario, according to an example.

FIG. 10 illustrates a scenario for performing remote diagnostics of an existing or new outdoor HVAC condenser unit's motors and motor power supply lines and reporting the unit's operational status, according to an example.

FIG. 11 illustrates a scenario for performing remote diagnostics of an existing or new outdoor HVAC condenser unit's coolant lines and reporting the unit's operational status, according to an example.

FIG. 12 illustrates a notional configuration for remote diagnostics of an existing or new outdoor HVAC condenser unit, as well as a wireless sensor hub that comprises a controller, and wireless or wired connectivity, according to an example.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the embodiments herein or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Many consumers are concerned about the quality of indoor air, and more particularly the presence of odors and/or pollutants that are present in the environment in which they may live and work. Studies have shown that exposure to particulates and gaseous pollutants commonly present in many indoor air situations, may increase allergies to those exposed, or exacerbate medical breathing conditions. To address this concern, there are numerous air cleaning and/or purifying products on the market that claim to eliminate odors and indoor air pollutants. However, to date, conventional systems do not utilize an air purifying device coupled to an HVAC system, particularly not one that incorporates the air purification mechanism within the HVAC system.

While most people are aware that outdoor air pollution may affect their health and well-being, many people may not realize that indoor air pollution, including pet pollutants, may also have even more harmful effects. In fact, recent studies suggest that indoor air may have two to five times the concentration of harmful contaminants as compared to that of outdoor air. Moreover, the effects of indoor air pollution are of further concern as most people spend most of their time indoors. Short term effects of exposure to contaminants in indoor air may result in symptoms such as headaches and fatigue, as well as irritation of the eyes, throat, and lungs. Long term effects of exposure to contaminants include heart disease, respiratory diseases, etc.

There are many sources of indoor air contaminants including those resulting from the use of cleaning supplies and from the emission of gasses from building materials, carpets, and paints. Other sources include contaminated outdoor air having pollen, dust, pets, and vehicle exhaust that may seep into the indoor environment. Other less-obvious sources of indoor air contaminants may result from cooking and preparation of food, the use of deodorizers or fragrances, the storage and disposal of food, and from daily activities such as cleaning, sweeping, and vacuuming.

More specifically, common indoor air contaminants include gasses such as volatile organic compounds (VOCs) and carbon dioxide (CO₂), as well as particulate matter (PM). VOCs can emanate from cleaning supplies, paints, furnishings, glues, adhesives, and alcohol. CO₂ is generated from respiration as well as from the burning of carbon and organic compounds. Particulate matter (PM) may be generated from cooking, combustion activities such as through the burning of candles, use of fireplaces, the use of unvented space heaters, and cigarette smoking. The relative concentration of the indoor air contaminants may vary greatly throughout the day in response to occupancy and activities that are occurring indoors. In another embodiment, natural gas can also be detected. When natural gas is detected, an alarm or warning or notification can be triggered. As such, the system could transition into a different operating mode, such as, but not limited to, a boost ventilation mode.

One measurement of air quality may be based on the relative concentration of contaminants and may be expressed as parts per million (ppm). Another measurement of air quality is the Air Quality Index (AQI), which presents the air quality as a numerical index. The AQI is determined by mathematical calculations based on pollution concentrations. The value of the AQI ranges from 0 to 500, in which the greater value of AQI represents more unhealthy air quality. The AQI is divided into six, color-coded categories, where each category reflects a specific range of AQI that is associated with specific health concerns. For example, air quality having an AQI value from 0 to 50 reflects air quality that is satisfactory, which poses little or no health risk, and is assigned to the color green. On the other extreme, air having an AQI in the range of 301 to 500 is considered as being hazardous, where there is a health warning of emergency conditions.

In response to the need to monitor indoor air quality, indoor air quality (IAQ) sensors are commercially available which can detect a range of gasses such as VOCs, CO₂, CO, radon, natural gas, the presence of PM, and can also detect barometric pressure, humidity, and temperature. The IAQ sensors may monitor the air quality immediately adjacent to the sensor and can detect temporal changes in air quality.

There are several techniques for controlling and reducing indoor air contaminants. One technique involves activating the ventilation of an air handling system such that contaminated indoor air is forced through one or more air filters to reduce the concentration of particulate matter. For example, the use of a High Efficiency Particulate Air (HEPA) filter may remove at least 99.97% of dust, pollen, mold, bacteria, and any airborne particles with a size of 0.3 micrometers (μm) or greater. Another technique for controlling indoor air contaminants is to dilute the indoor air with outdoor air by activating fresh air dampers for example. Other techniques include the use of air purifiers such as those that employ ultraviolent (UV) light sources to reduce air contaminants such as mold, or air ionizers to remove particles from air.

Embodiments herein describe an air purifier or air purification system incorporated within an HVAC system. In one example, the air purifier is configured to be positioned on the return duct of an HVAC system. In another example, the air purifier is configured to be positioned between a supply duct and the HVAC system. In yet another example, the air purifier is configured to be positioned on the supply duct of an HVAC system. One skilled in the art can contemplate placing the air purifier in any desired manner or location with respect to a supply duct, return duct, and/or HVAC system to meet desired design requirements. The air purifier includes an intake channel (for receiving fresh air from the outside) and an outtake channel (for ejecting or discharging stale air to the outside). The air purifier further includes a first fan mounted on the intake flow and in communication with the control system and a second fan installed on the exhaust flow and in communication with the control system. The first and second fans are independently operable with respect to each other. The first and second fans can be run at different speeds. The independent fan speeds help accomplish different goals (temperature balance, negative/positive pressure balance, etc.). In response to detecting an adverse air quality event within a structure, such as a building or home, by one or more sensors, a speed of the first fan and a speed of the second fan can be automatically adjusted (i) to maintain an airflow ratio between air inflow and air outflow within the air purifier and (ii) to introduce increased fresh air flow from outside the structure, building or home's building envelope and (iii) to improve the overall filtration effectiveness by increasing the overall airflow rate and (iv) to examine the filter's performance and remaining lifespan by measuring pressure across the filter(s). In one example, one or more sensors can be connected to multiple locations on the HVAC ducts and occupied spaces.

Regarding the improvement of the overall filtration effectiveness, this can be achieved by a number of different ways. For example, when detecting gasses, ventilation can be increased by, e.g., boosting the fans, which are adjusted independently to achieve balance goals. When detecting PM, filtration can be increased (by boosting the main fans) and ventilation can also be increased (by boosting the fans). This may depend on the source of the PM (e.g., outside air is the source of PM). When outside air quality (AQ) triggered conditions are detected, ventilation can be temporarily reduced while maintaining positive pressure until adverse outside conditions are resolved. When AQ conditions are generated by a user (e.g., a hazardous event), ventilation can be temporarily reduced while maintaining positive pressure until adverse outside conditions are resolved. In another example, the system may be in “vacation” mode or “unoccupied” mode where energy usage is minimized while maintaining optimal ventilation for prevention of, e.g., mold, dust accumulation, etc. or to respond to adverse conditions. When the user or occupants return home, the “unoccupied” mode can be disabled during a predefined time before the user or occupants arrive home.

In another example, the sensors can be incorporated within thermostats within the structure or building or home. The first and second sensors can measure a plurality of different variables related to air borne particles or particulate matter within the structure or building or home. The measurements can be provided to a computing device operated or handled by an onsite or remote user. In one example, the user can set the thresholds related to the measurements. In another example, the manufacturer sets the thresholds related to the measurements. In a third example, the manufacturer deploys a machine learning system that automatically and optimally adjusts thresholds based on building usage, measured effectiveness, and user preferences and behavior. As such, the air quality within a structure or building or home can be constantly or continuously or periodically improved by adding or integrating an air purifier to the existing HVAC system, where the air purifier takes action when detecting an adverse air quality event by dynamically and automatically adjusting the speed (or input power to the motor) of the first and second fans of the intake and exhaust channels, to control fresh air flow within the structure or building or home.

Moreover, the exemplary embodiments provide the capability to sense occupancy load and make optimal decisions based on the occupancy. Occupancy load can be detected by employing one or more sensors, such as, but not limited to, passive infrared (PIR) motion sensors, cameras, and/or low-power Doppler radar sensors. These sensors can provide information related to the number of people in a room and measure the activity level of each person within the room, which can be used to adjust the system's required fresh air intake accordingly.

In another example, the sensors can be incorporated within thermostats within the structure or building or home. The first and second sensors can measure a plurality of different variables related to air borne particles or particulate matter within the structure or building or home. The measurements can be provided to a computing device operated or handled by an onsite or remote user. In one example, the user can set the thresholds related to the measurements. In another example, the manufacturer sets the thresholds related to the measurements. In a third example, the manufacturer deploys a machine learning system that automatically and optimally adjusts thresholds based on building usage, measured effectiveness, and user preferences and behavior. As such, the air quality within a structure or building or home can be constantly or continuously or periodically improved by adding or integrating an air purifier to the existing HVAC system, where the air purifier takes action when detecting an adverse air quality event by dynamically and automatically adjusting the speed (or input power to the motor) of the first and second fans of the intake and exhaust channels, to control fresh air flow within the structure or building or home.

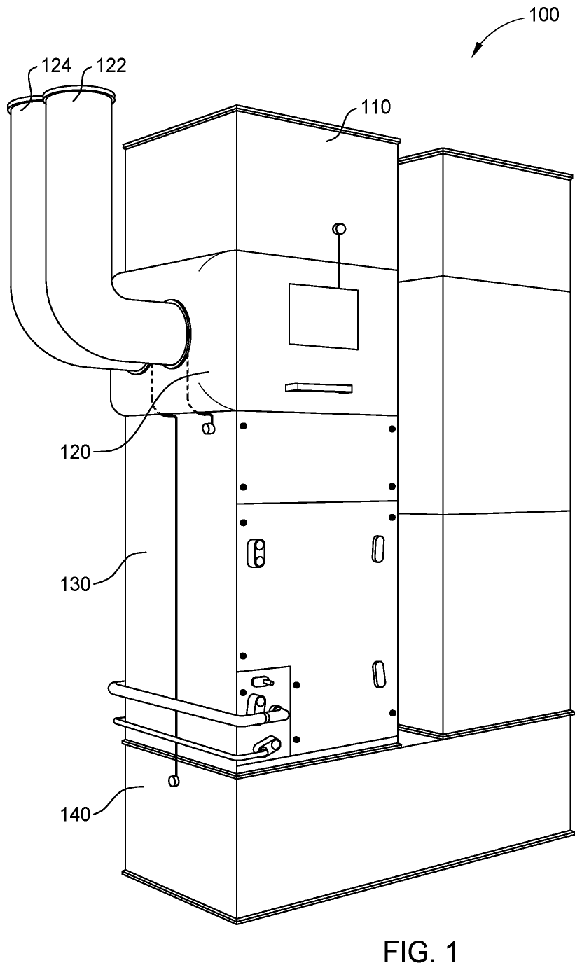

FIG. 1 illustrates a perspective view of an inline system including an air purification system integrated with a heating, ventilation, and air conditioning (HVAC) system, according to an example.

The inline system 100 includes a return duct 110, an air purification system 120, an HVAC system 130, and a supply duct 140. The air purification system 120 includes an intake channel 122 and an exhaust channel 124. The air purification system 120 is positioned directly between the return duct 110 and the HVAC system 130. The air purification system 120 can be easily installed or integrated with or incorporated with different types of HVAC systems 130.

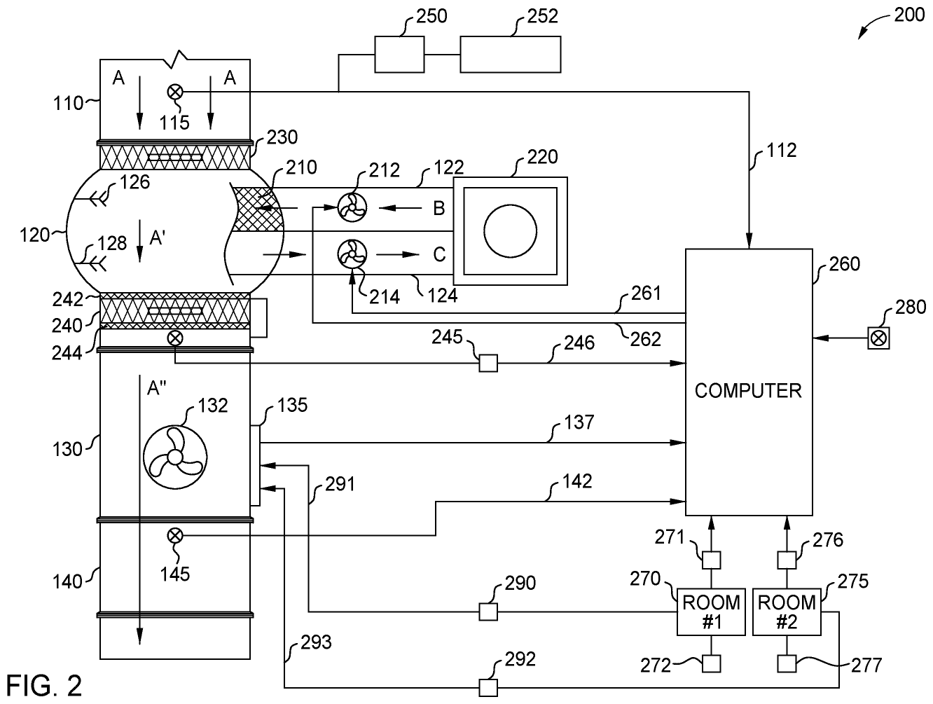

FIG. 2 is a schematic view 200 of the air purification system integrated with the HVAC system, according to an example.

Air enters the return duct 110 and travels in a direction A toward the air purification system 120. A first filter 230 is positioned between the return duct 110 and the air purification system 120. In one example, the first filter 230 is a debris and carbon filter. The air passes from the return duct 110 through the first filter 230 and into the air purification system 120. The air travels in a direction A′ within the air purification system 120.

The return duct 110 includes a first sensor 115. The first sensor 115 collects data and transmits such data via a connection 112 to a computer 260. The first sensor 115 can include an air quality sensor 250 and an air pressure sensor 252. The computer 260 can be referred to as a central processing unit (CPU) or one or more CPUs. The computer 260 can be referred to as a controller or microcontroller. The first sensor 115 measures air quality in the return duct 110.

The air purification system 120 includes the intake channel 122 and the exhaust channel 124. The intake channel 122 and the exhaust channel 124 are stabilized or supported by an external wall plate 220. The intake channel 122 receives fresh air from the outside. The fresh air moves in a direction B. The exhaust channel 124 pulls stale air to the outside. The stale air moves in a direction C. A first fan 212 is positioned within the intake channel 122 and a second fan 214 is positioned within the exhaust channel 124. The first and second fans 212, 214 are multi-speed fans.

An energy recovery ventilator (ERV) 210 is placed within the air purification system 120. The ERV 210 is placed adjacent to the intake channel 122 such that fresh air pulled in by the first fan 212 of the intake channel 122 passes through the ERV 210. The ERV 210 is a type of mechanical equipment that allows two intake and exhaust streams of airflow exchange both heat and humidity without letting the two flows mix together. In summer, warm and humid outside air is pre-cooled and dehumidified via the total energy from the outgoing cool interior air. In winter, cold and dry outside air is pre-heated and humidified via the total energy from the outgoing warm interior air. As such, less energy is needed for conditioning and ventilation, which reduces the strain on the HVAC system 130.

The air purification system 120 further includes an Ultraviolet-C (UVC) light. In one example, a first UVC light 126 and a second UVC light 128 are positioned within the air purification system 120. The UVC lights 126, 128 are applied to the air coming in from the return duct 110 and the air coming in from the intake channel 122 and through the ERV 210. In one example, the UVC lights can be combined into a single UVC light. In one example, the UVC lights 126, 128 can be positioned or placed in any area or location within the air purification system 120.

The HVAC system 130 is connected to or attached to or cooperates with the air purification system 120. A second filter 240 is positioned between the air purification system 120 and the HVAC system 130. In one example, the second filter 240 is an ionization filter. A top surface 242 of the ionization filter has a positive charge and a bottom surface 244 of the ionization filter has a negative charge. The ionization filter 240 has a minimum efficiency reporting value (MERV) rating. MERV reports a filter's ability to capture larger particles between 0.3 μm and 10 μm. In one example, the ionization filter 240 has a MERV rating of 15. One skilled in the art can contemplate using ionization filters with other desirable MERV ratings.

The HVAC system 130 includes an air handler 132. The HVAC system 130 further includes a controller 135 on an exterior surface thereof. Air flows from the air purification system 120 through the ionization filter 240 and travels in a direction A″ within the HVAC system 130 and into the supply duct 140.

The HVAC system 130 may be used to thermally regulate a space within a building, home, or other suitable structure. For example, the HVAC system 130 may include a direct expansion or heat pump system (not shown) that transfers thermal energy between a heat transfer fluid (not shown), such as a refrigerant, and a fluid to be conditioned, such as air. The direct expansion system may include a condenser (not shown) and an evaporator (not shown) that are fluidly coupled to one another via a conduit. A compressor may be used to circulate the refrigerant through the conduit and, thus, enable the transfer of thermal energy between the condenser and the evaporator. Other HVAC systems (not illustrated here) such as forced air furnaces, absorption systems or evaporative units can also similarly be connected to this proposed air purification system.

In many cases, the evaporator coils of the HVAC system 130 may be used to condition a flow of air entering a building from an ambient environment, such as the atmosphere. For example, in cases when the HVAC system 130 is operating in a cooling mode, the supply duct 140 may direct outdoor air across a heat exchange area of the evaporator, such that the refrigerant within the evaporator absorbs thermal energy from the outdoor air.

In certain cases, the HVAC system 130 may exhaust stale air from within the building while simultaneously directing the conditioned air into the building in cooperation with the air purification system 120. Accordingly, a continuous supply of fresh air may be circulated through an interior of the building, which may improve an air quality within the building. In some cases, the HVAC system 130 may direct indoor air discharged from the building through an ERV (not shown) prior to releasing the indoor air into the atmosphere. The ERV may use heat transfer components, such as an ERV core 210, to recover thermal energy from the discharging indoor air. For example, fresh outdoor air entering the HVAC system 130 may be of a higher temperature than the indoor air discharging from the building. The ERV may facilitate heat transfer between the outdoor air to be cooled and the discharging indoor air, such that the cooler indoor air may absorb thermal energy from the incoming and warmer outdoor air. Therefore, the ERV may pre-cool the outdoor air before the outdoor air flows through the evaporator of the HVAC system 130. This may decrease an amount of energy used by the HVAC system 130 to cool the incoming outdoor air, thereby increasing an efficiency of the HVAC system 130.

The air purification system 120 is integrated with the HVAC system 130. The HVAC system 130 cooperates with the air purification system 120 to supply fresh air to the home or building or structure.

The supply duct 140 includes a second sensor 145. The supply duct 140 is positioned adjacent to the HVAC system 130, in opposed relation to the air purification system 120. The second sensor 145 collects data and transmits such data via a connection 142 to the computer 260 (or controller). The second sensor 145 can be an air quality sensor and an air pressure sensor.

In one example, the first and second sensors 115, 145 are connected to one or more thermostats (not shown) cooperating with the HVAC system 130 within the structure. The thermostats themselves can also monitor air quality within rooms of the house. The data from the thermostats is also provided to the computer 260 (or controller).

The first fan 212 is independently operable with respect to the second fan 214. In certain situations, the speed of the first fan 212 is different than the speed of the second fan 214. For example, when an adverse air quality event is detected (or negative pressure) within the house, the speeds of the first and second fans 212, 214 are changed or adjusted or modified or fine-tuned such that more fresh air enters the intake channel 122 from the outside. In such case, the speeds of the first and second fans 212, 214 can be different with respect to each other. The fresh air is distributed to the rooms of the structure that experienced the adverse air quality event (or negative air pressure). When no adverse air quality event is detected, a 1:1 airflow ratio can be maintained between the first fan 212 and the second fan 214. In such case, the speed of the first and second fans 212, 214 can remain the same.

In other words, when no negative pressure is detected, and air quality is acceptable or safe, the first fan 212 can operate at a normal speed (or at the default input power to its motor) and the second fan 214 can operate at a normal speed (or horsepower of its motor). In such instance, a 1:1 airflow ratio can be maintained between the first fan 212 and the second fan 214. However, when negative pressure is detected within one or more rooms of the building envelope, a poor air quality score is computed, and the speed of the first fan 212 is increased or ramped up to allow more fresh air to enter from the outside through the intake channel 122. The speed of the first fan 212 can increase to much higher rates depending on how poor the air quality score is. In one example, the speed of the second fan 214 can also increase at the same rate as the first fan 212. In another example, the speed of the second fan 214 can increase at a different rate compared to the speed of the first fan 212. As such, poor quality or compromised air can be siphoned out at an equal rate to the fresh air coming into the inline system 100 or at a different rate compared to the fresh air coming into the inline system 100. Thus, the speed of the first fan 212 can be different than the speed of the second fan 214. For instance, the first fan 212 can run at 5× its original speed, whereas the second fan 214 can run at 2.5× its original speed indicating that more fresh air is pumped through the inline system 100 and into the affected room than air pumped to the outside. The relationship between the inflow air and outflow air is based on the number of variables that exceed their respective thresholds, as well as the amount each variable exceeds its respective threshold. High variations over set thresholds can cause the first fan 212 and the second fan 214 to ramp up significantly to meet fresh air intake demands.

Moreover, for the ERV 210 to operate properly, the intake air B (in the intake channel 122) and the outtake or exhaust air C (in the exhaust channel 124) should have a 1:1 airflow ratio correlation. However, when an adverse air quality event is detected (or negative air pressure), the intake air B is increased or ramped up such that the 1:1 airflow ratio correlation is temporality not maintained until an air pressure balance is reinstated within the building envelope. As such, the 1:1 airflow ratio correlation between the intake channel 122 and the exhaust channel 124 is temporarily disrupted when an adverse air quality event is detected and remediation takes place, remediation being adjustment of the fan speeds within the intake channel 122 and the exhaust channel 124.

Referring back to the air purification system 120, the air purification system 120 is positioned directly between the return duct 110 and the HVAC system 130. The air purification system 120 is configured to purify the air within a structure or building or home. For example, in response to detecting an adverse air quality event within the building envelope by the first sensor 115 and the second sensor 145, the air purification system 120 automatically adjusts a speed of the first fan 212 and a speed of the second fan 214 to maintain an air flow ratio between air inflow and air outflow within the HVAC system 130 to ensure air pressure within the building envelope is balanced. The air purification system 120 further introduces increased fresh and filtered air flow from outside the building envelope and increases filtration of indoor air. The data collected by the computer 260 (or controller) is used to control or adjust or regulate or fine-tune the first fan 212 and the second fan 214. In one example, data is transmitted from the computer 260 via communication line 261 to the first fan 212 and data is transmitted from the computer 260 via communication line 262 to the second fan 214. Thus, data collected by the computer 260 is processed in real-time to make real-time adjustments to the speeds of the first and second fans 212, 214.

The air purification system 120 advantageously adjusts the speeds of the first and second fans 212, 214 whenever an adverse air quality event is detected (or negative air pressure) within the building envelope. In particular, the speed of the first fan 212 is increased or ramped up to bring in more fresh air from the outside. The speed of the first fan 212 can have a direct correlation to how low or poor the air quality is within the structure or rooms of the structure. In one example, if the air quality is poor due to one adverse air quality event (e.g., slightly high CO₂), the speed of the first fan 212 can be adjusted by 0.5×. In another example, if the air quality is poor due to one adverse air quality event (e.g., excessively high CO₂), the speed of the first fan 212 can be adjusted to a significantly higher speed. Therefore, a direct correlation or relationship may exist between a speed of the first fan 212 and specific poor air quality number measurements. Additionally, if the air quality is poor due to several adverse air quality events (e.g., high CO₂, high Rn, high SO₂, and high VOCs), the speed of the first fan 212 can be adjusted to a significantly higher speed. High abnormal number measurements (significantly above a threshold) can trigger the speed of the first fan 212 to operate at a very high or maximum rate. The goal is to funnel in as much outside fresh air as quickly as possible to rebalance the air quality within the building envelope. Minor air quality adjustments may require minimal increased fan speed, whereas major air quality adjustments may require maximum increased fan speed. Specific speed rates can be based on a magnitude of variation for each of the one or more variables.

Adverse air quality events are triggered when one or more variables exceed a predetermined or set threshold. The one or more variables are one or more of at least air pressure, temperature, humidity, carbon dioxide (CO₂), carbon monoxide (CO), radon (Rn), nitrogen dioxide (NO₂), sulfur dioxide (SO₂), benzene (C₆H₆), volatile organic compound (VOC), Polycyclic Aromatic Hydrocarbons (PAH) readings, and particulate readings. The one or more variables are not limited to such list. Other variables causing adverse air quality events may be contemplated.

Referring back to the HVAC system 130, the controller 135 directly communicates with the computer 260 via communication line 137. The controller 135 also receives data from various rooms in the house. Also, one or more HVAC sensors can communicate HVAC data with a wireless link 245 to the computer 260 via communication line 246.

In one example, a first room 270 communicates via a wireless link 271 with the computer 260 to provide the computer 260 with air quality data. The first room 270 includes sensors 272. In one example, the sensors 272 are air quality and air pressure sensors. Similarly, a second room 275 communicates via a wireless link 276 with the computer 260 to provide the computer 260 with air quality data. The second room 275 includes sensors 277. In one example, the sensors 277 are air quality and air pressure sensors. In one example, the computer 260 can be any type of controller.

One skilled in the art can contemplate each room or area within a house to have sensors for collecting data for each respective room. Data collected by sensors in each room are forwarded to the computer 260 and the controller 135. Data collected by the computer 260 can be transmitted via, e.g., a wireless link 280 to an electronic device operated or handled by a user. The electronic device can be, e.g., a computer or tablet or smart phone or smart television or any other electronic device having at least one display device. The electronic device can include any or all of the following capabilities: voice detection and control, voice readout and response, environment, activity and occupancy detection, machine learning methods of analysis for detection of system faults, learning of user preferences, and learning of a particular structure's environmental response to the system's purification functionality.

As such, each zone within a house can provide air quality data to the computer 260, as each room can be equipped with air quality and air pressure sensors, as well as temperature, humidity, and occupancy sensors, such as, but not limited to, radar sensors. The air quality data collected regarding the first room 270 is also communicated via a wireless link 290 to the controller 135 of the HVAC system 130 via communication line 291. Similarly, the air quality data collected regarding the second room 275 is also communicated via a wireless link 292 to the controller 135 of the HVAC system 130 via communication line 293.

The controller 135 can adjust operation of the air purification system 120 and the HVAC system 130 based on the data collected from each of the rooms of the house. For example, it may be determined that the air quality within the first room 270 is poor. For instance, an air quality score of 301 was computed. However, the air quality within all the other rooms within the house are excellent, fair or acceptable. As such, the controller 135 can adjust the speed of the first fan 212 and the speed of the second fan 214 to provide for better air quality within the first room 270. In one example, the speed of the first fan 212 is increased to introduce increased fresh and filtered air flow from outside the house.

The app on the computing device can inform the user that the speed of the first fan 212 has been increased from a first level to a second level, and that the air quality score should decrease from 301 to 45 within approximately 35 minutes. Once, the air quality score of the first room 270 has been adjusted to an acceptable level (by adjusting the speeds of the first fan 212 and the second fan 214 to funnel in more fresh air from the outside), the app can inform the user that the speed of the first fan 212 has been reduced to its default or normal operating level. Reverting the first fan 212 back to its original or initial speed will reinstate a 1:1 correlation ratio between the inflow (the intake channel 122) and the outflow (the exhaust channel 124), which enables the ERV 210 to operate as intended.

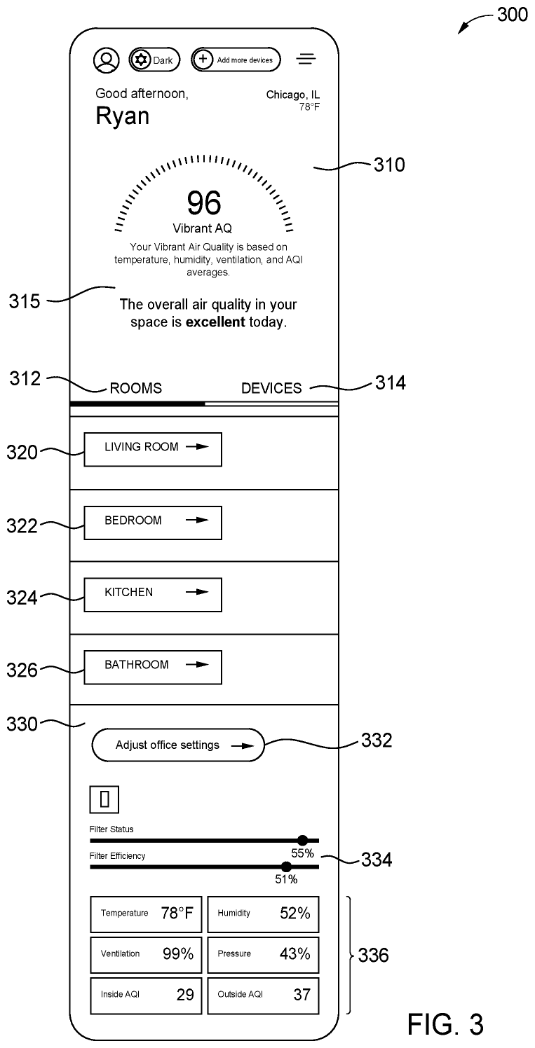

FIG. 3 illustrates a first screenshot on a graphical user interface (GUI) depicting air quality within rooms of a house, according to an example.

The GUI can be displayed on a display screen of a computer or tablet or smart phone or smart television or any other electronic or computing device. The first screenshot 300 depicts a display area 310 greeting the user and providing an air quality score 315. In one example, the air quality score of the entire space was computed to be 96. Additionally, the air quality score 315 is accompanied by other information. In one instance, the user is provided with information indicating that the air quality score 315 was based on temperature, humidity, ventilation, and air quality index (AQI) averages. One skilled in the art can contemplate a plurality of different information displayed in the display area 310. One skilled in the art can also contemplate computing an air quality score from different combinations of measured variables using a variety of different formulas.

The display areas 310 also includes a “ROOMS” selection button 312 and a “DEVICES” selection button 314. When the “ROOMS” selection button 312 is chosen by a user, each room of the house can be displayed. In one example, the rooms can include a living room 320, a bedroom 322, a kitchen 324, and a bathroom 326. In one example, the air quality score 315 is derived from, e.g., temperature, humidity, ventilation, and air AQI averages measured in each room of the house. In another example, averages from other measured variables can be used. In one example, a user chooses or selects which rooms of the house to extract data from to compute an air quality score. For instance, the user can select all the rooms of the first floor of the house to determine an air quality score with respect to the first floor only. Similarly, the user can select all the rooms of the second floor of the house to determine an air quality score with respect to the second floor only. In another example, the user can select only all the bedrooms in the house regardless of which floor such bedrooms are located in. As such, the user has the capability to select any combination of rooms within a house to determine various air quality scores. In other words, air quality measurements can be room-specific or floor-specific, and air quality adjustments can be made only to one or more affected rooms.

A display area 330 provides the user with additional information such as a settings adjustment button 332, as well as slide bars 334 for viewing different parameters of filter data. In one example, the first slide bar provides filter status information and the second slide bar provides filter efficiency information. One skilled in the art can contemplate providing any type of useful information to the user. Additionally, one or more variables 336 can be displayed, such as, but not limited to, temperature, ventilation, interior AQI, humidity, pressure, and outside AQI.

In one example, the information displayed on the screenshot 300 can be changed or adjusted or modified by the user. In another example, the information displayed on the screenshot 300 can be preset by the manufacturer.

At least temperature (degrees), relative humidity (%), airflow (air changes per hour (ACH)), and AQI are presented on the GUI. Temperature and humidity are user-defined preferences. Airflow is a reading of the current air exchange rate, which will be partly dependent on the AQI at the time of the ACH reading. In one example, the level of air changes per hour that are achieved are ideally at least double the ACH code. The inline system 100 ideally achieves at least approximately 0.70 ACH per hour. However, in certain situations, the ACH achieved can be anywhere between 0.35 ACH and 0.7 ACH. In other situations, the ACH achieved can be over 0.7 ACH. The ACH levels achieved do not limit the scope of this invention. Regarding the AQI, at least two factors that will come into play are the gas mix of the internal air (oxygen, CO, CO₂, NO₂) and the level of pollutants, particulate matter, and contaminants (VOCs, smoke, particulate matter emitted from household products like carpets, plastics, etc., asbestos, mold and mildew, radon, pesticides, benzopyrene, bacteria, animal dander, etc.). If the sensors detect levels above set thresholds for the gas mix (CO, CO₂, O₂), the inline system 100 will introduce additional outdoor air. If the sensors detect pollutants or contaminants above set thresholds, this triggers both the introduction of additional outdoor air (assuming outdoor air is not polluted) and additional purification cycles through the filtration system.

Regarding threshold settings, in one example, the user sets ranges for different variables (user-controlled variables). In another example, the settings are preset by the manufacturer (e.g., when drafting the specification/description). If the user inputs a setting that exceeds recommended levels, a warning or notification is provided to the user. For example, if the outdoor temperature is 100 OF and the user sets the indoor temperature to 110° F., the user will be issued a warning. A constant warning icon may be present on the GUI main screen. Moreover, ideal indoor CO₂ levels will match natural outdoor air levels at around 400 ppm. As such, the threshold setting for CO₂ should be around 600 ppm, which will prompt the sensor to inform the system to introduce more external air. NO₂ should be no higher than the environmental protection agency (EPA) limit for outdoor air (i.e., 0.053 ppm). CO levels should be no higher than 10 ppm, which is below all recommendations from the occupational safety and health act (OSHA), EPA, etc. VOC levels should be lower than 0.05 ppm, which matches the world health organization (WHO) recommendation and is well below leadership in energy and environmental design (LEED) and OSHA requirements. Radon should be below 0.4 pCi/L, which matches outdoor air.

Moreover, the threshold settings can be modifiable in 1% increments (1 degree, 1%, etc.) There are hard-coded levels that the user cannot override using the regular interface (e.g., CO₂ above 1400 ppm, CO above 25 ppm, NO₂ above 0.06 ppm, radon above 4 pCi/L, and VOCs above 50 ppm). The user should be able to override these levels using a series of button presses that isn't readily available. For example, the user can call and receive the code for the override, or an HVAC professional can override it for the user by button presses, similar to how some thermostats operate. Levels above the maximum threshold are considered dangerous, but might need to be tolerated by the system temporarily in certain scenarios like home renovations, etc. These are hard-coded maximum levels for normal user overrides.

Improvements to the air quality within the house can be monitored in real-time by the user. In one example, the screenshot 300 or another screenshot indicates to the user that one or more adverse air quality events have occurred. The specific one or more adverse air quality events are indicated to the user on a display. For example, the CO₂ is above 700 ppm, the NO₂ is above 0.05 ppm, and the VOCs are above 35 ppm. The screenshot 300 or another screenshot indicates that the speed of first fan 212 and the speed of the second fan 214 have been adjusted (e.g., 5× increase in speed) to quickly pull in fresh air from the outside via the intake channel 122 and to quickly discharge poor quality or stale air or compromised air out of the home via the exhaust channel 124.

The air quality index score can be dynamically changed as fresh air first enters the inline system 100 and then the home. The dynamically changing air quality index score is displayed to the user continuously, in real-time. As more fresh air enters the inline system 100, the air quality score for one or more rooms slowly or progressively changes from say, 35, to 40, to 50, to 60, etc. until it reaches an acceptable or safe level (say 85 or 90). The time it takes for this change to occur is provided to the user in real-time. In the instant example, the air quality index score change for one particular room can occur in, e.g., 23 minutes.

The user is provided with an overall air quality index score, as well as air quality index scores for each room or for a combination of rooms. For example, a first room can be shown to have an air quality index score of 90, a second room can be shown to have an air quality index score of 92, a third room can be shown to have an air quality index score of 95, etc. Additionally, an average air quality index score of 91 can be provided for the average air quality index of all the bedrooms in the house. Similarly, an average air quality index score of 94 can be provided for the average air quality index of all rooms on the second floor of the house. As such, the user is provided with a plurality of different air quality index scores based on computations from each single room or based on computations of different combinations of rooms.

The user is also provided with the updated CO₂, NO₂, and VOC data showing all three variables below their respective thresholds. One skilled in the art can contemplate displaying any combination of information to the user. In one example, the template for the GUI can be modified by the user based on desired needs. The user can also rearrange the icons or items or data on the display to accommodate user preferences.

In one example, all the adverse air quality events can be stored in one or more databases (not shown). Such data can be designated as historical data. The user can thus search the one or more databases for prior incidents of adverse air quality events. For instance, a user may experience a high CO₂ event in March 2023. The user recalls a similar high CO₂ event that occurred at the end of 2021 but cannot remember the specific date or time or CO₂ reading. As such, the user can access the one or more databases with the historical data to discover the specific date and time and CO₂ reading, as well as the time it took to remediate or fix such similar issue, and compare such data from the past event to the current event. The user can also be provided with a weekly or monthly or yearly adverse air quality event report. Such reports can be automatically stored in one or more databases or on the app.

In another example, the historical adverse air quality events detected in a first home can be compared to historical adverse air quality events detected in other homes. For example, the historical adverse air quality events of each home can be automatically sent, with the user's consent, to a central or cloud-based database that compares adverse air quality events between homes of same block, or neighborhood or town, etc. In one instance, it may be determined that several homes within a first neighborhood of a first town experienced many adverse air quality events related to high VOC readings. Also, it may be determined that several homes within a second neighborhood of the first town experienced many adverse air quality events related to high NO₂ readings. Such collected data can be used to inform homeowners of similar adverse air quality events within their neighborhood and may be used by towns to educate residents to better equip their homes to prevent such occurrences.

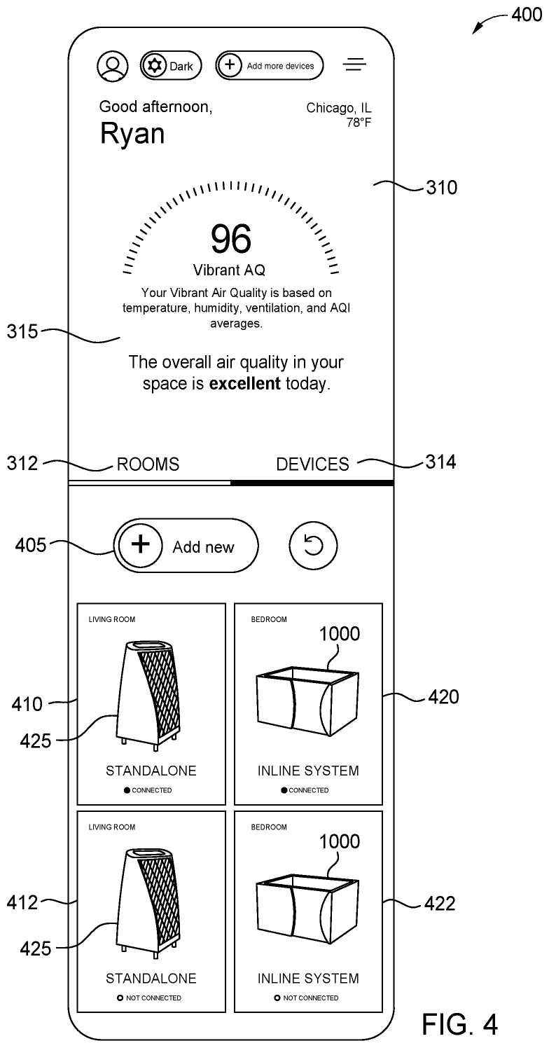

FIG. 4 illustrates a second screenshot on the GUI depicting air purification system connections to rooms of a house, according to an example.

As noted above, the GUI can be displayed on a display screen of a computer or tablet or smart phone or smart television or any other electronic or computing device. When the “DEVICES” selection button 314 is chosen by the user, each air purifier device of the house can be displayed. In one example, the inline system 100 described herein is displayed. In another example, a standalone air purifier unit 425 is displayed.

The second screenshot 400 depicts the display area 310 greeting the user and providing the air quality score 315. In one example, the air quality score of the entire space was determined to be 96. Additionally, the air quality score 315 can be accompanied by other information, as described above with reference to FIG. 3.

The second screenshot 400 further includes an “add new” button 405 allowing the user to connect other air purification systems, whether inline or standalone. The second screenshot 400 allows the user to determine whether each room is connected or not connected to an air purification system. An icon 410 indicates that a standalone air purification system is connected in a living room in one instance and an icon 412 indicates that a standalone air purification system is not connected in the living room in another instance. An indication or image can be provided regarding standalone air purification system connection information for each room in the house. Similarly, an icon 420 indicates that a standalone air purification system is connected in a bedroom in one instance and an icon 422 indicates that a standalone air purification system is not connected in the bedroom in another instance. An indication or image or icon can be provided regarding an inline air purification system connection information for each room in the house. Therefore, an air purification connection status of each room can be provided to the user in real-time. This allows the user to advantageously determine which rooms within a house are connected to which type of air purification system in real-time.

It is contemplated that the user can activate or disable any type of air purification system with respect to each room. In one example, the user may disable all the standalone air purifications systems within the house and activate only the inline air purification system. In another example, on a hot day, the user may wish to share the load between standalone and inline air purification systems. The user can thus control activation and disablement of different air purification systems within a house or building or structure to better regulate air flow within each room of a building or structure. All this data is provided to the user in real-time on the app.

In another example, a lockout feature can be displayed on the GUI to automatically disable a user account if the user fails to provide the correct password or fingerprint after a specified number of attempts. For example, the user may wish to lock out children trying to access the app.

Regarding FIGS. 3 and 4, each metric will be clickable, and when the user clicks that metric, the GUI defines what it is measuring, how it is measuring it, and indicates what it is detecting. For example, if a user clicks the air quality index measurement, it shows the user what pollutants it has measured, what their levels are, and what the system is doing to correct it. Clicking air flow will show air changes per hour.

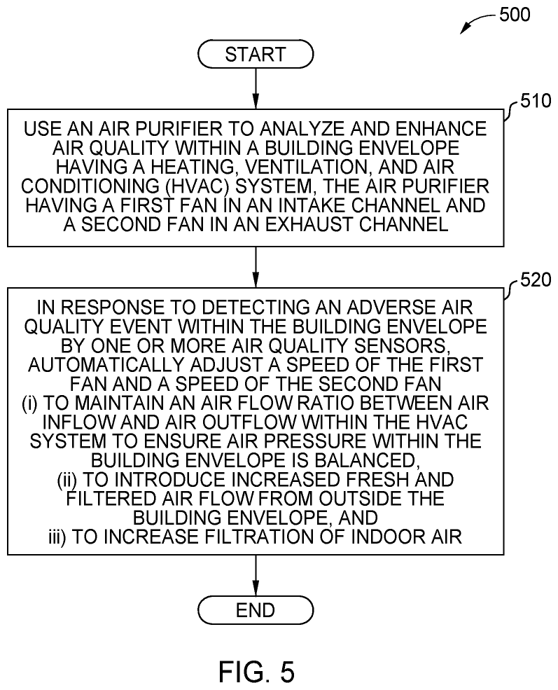

FIG. 5 illustrates a method 500 for purifying air within a house, according to an example.

At block 510, an air purifier is used to analyze and enhance air quality within a structure having a heating, ventilation, and air conditioning (HVAC) system, the air purifier having a first fan in an intake channel and a second fan in an exhaust channel.

At block 520, in response to detecting an adverse air quality event within the building envelope by a one or more air quality sensors, a speed of the first fan and a speed of the second fan are automatically adjusted (i) to maintain an air flow ratio between air inflow and air outflow within the HVAC system to ensure air pressure within the building envelope is balanced, (ii) to introduce increased fresh and filtered air flow from outside the building envelope, and (iii) to increase filtration of indoor air.

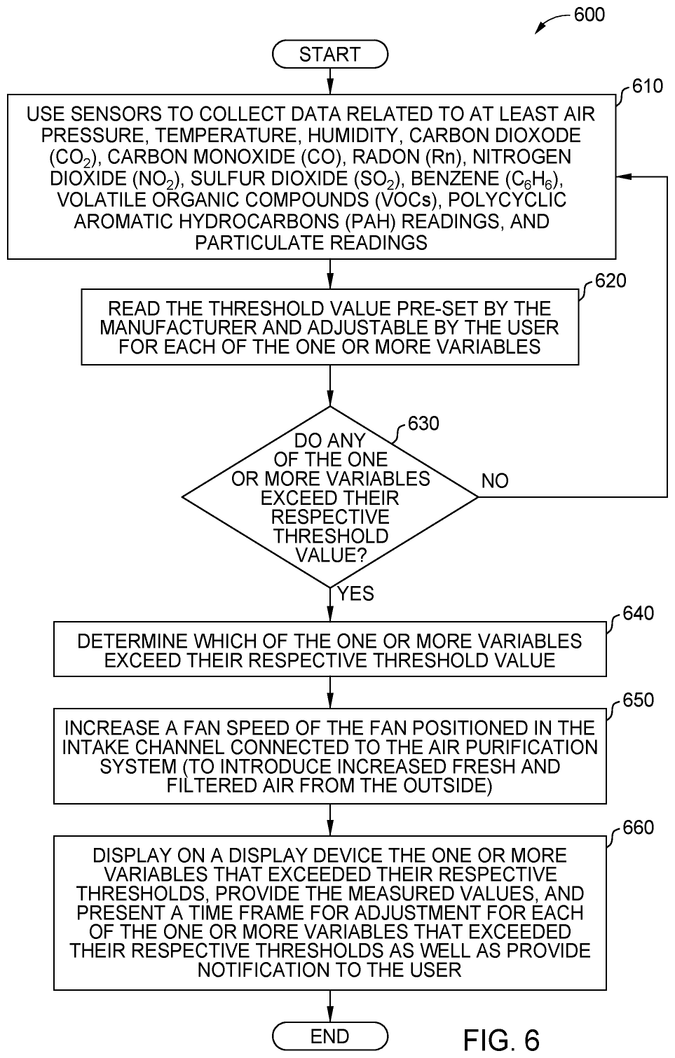

FIG. 6 illustrates a first sensor scenario 600, according to an example.

At block 610, sensors are used to collect data related to at least air pressure, temperature, humidity, carbon dioxide (CO₂), carbon monoxide (CO), radon (Rn), natural gas, nitrogen dioxide (NO₂), sulfur dioxide (SO₂), benzene (C₆H₆), volatile organic compounds (VOCs), Polycyclic Aromatic Hydrocarbons (PAH) readings, and particulate readings.

At block 620, the threshold value pre-set by the manufacturer and adjustable by the user are read for each of the one or more variables. The threshold values can be stored in one or more databases or on the app.

At block 630, it is determined whether any of the one or more variables exceed their respective threshold value. If NO, proceed back to block 610. If YES, proceed to block 640.

At block 640, it is determined which of the one or more variables exceed their respective threshold value. The one or more variables that exceed their respective thresholds may be displayed on a display of a computing device for the user to view.

At block 650, a fan speed of the fan positioned in the intake channel connected to the air purification system is increased (to introduce increased fresh and filtered air from the outside). A speed of the first fan and a speed of the second fan can be increased at a same rate or at a different rate based on the number of variables exceeding their respective thresholds, and by an amount of overshoot.

At block 660, the one or more variables that exceeded their respective thresholds are displayed, on a display device, the measured values are provided, and a time frame for adjustment for each of the one or more variables that exceeded their respective thresholds is presented. The method for purifying air within a structure thus detects negative air pressure within the building envelope by using an air purifier having a first fan in an intake channel and a second fan in an exhaust channel, and introduces increased fresh air flow from outside the building envelope by automatically adjusting a speed of the first fan. The air flow ratio is maintained between air inflow and air outflow within an HVAC system to ensure air pressure within the building envelope is balanced. The notification may also be provided to the user.

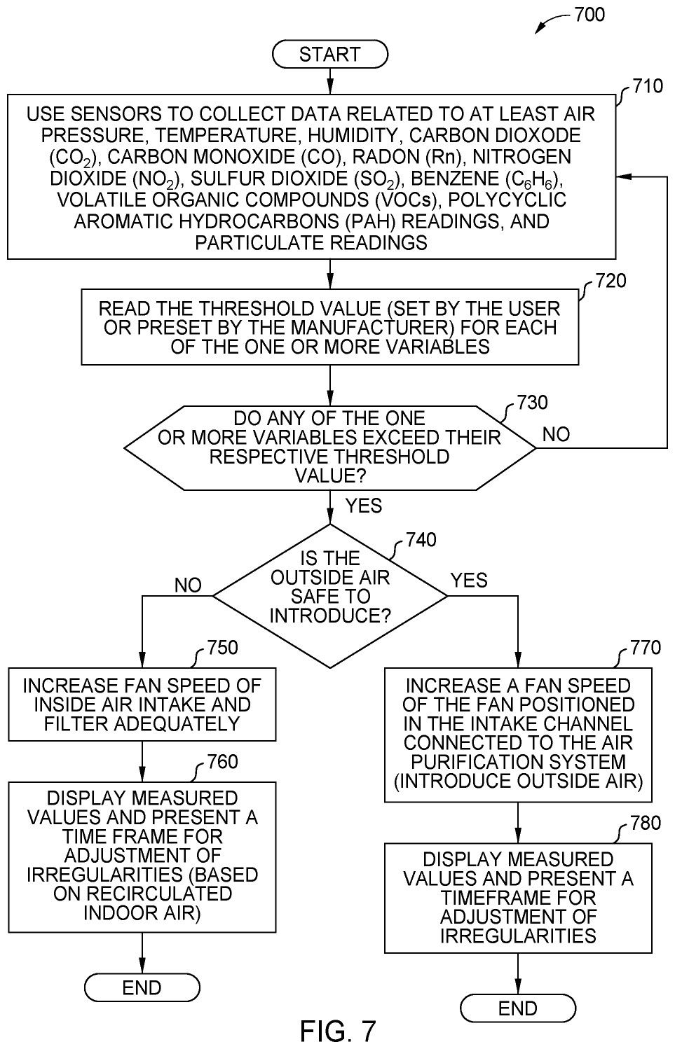

FIG. 7 illustrates a second sensor scenario 700, according to an example.

At block 710, sensors are used to collect data related to at least air pressure, temperature, humidity, carbon dioxide (CO₂), carbon monoxide (CO), radon (Rn), natural gas, nitrogen dioxide (NO₂), sulfur dioxide (SO₂), benzene (C₆H₆), volatile organic compounds (VOCs), Polycyclic Aromatic Hydrocarbons (PAH) readings, and particulate readings.

At block 720, the threshold value (set by the user or preset by the manufacturer) are read for each of the one or more variables. The threshold values can be stored in one or more databases or on the app.

At block 730, it is determined whether any of the one or more variables exceed their respective threshold value. If NO, proceed back to block 710. If YES, proceed to block 740.

At block 740, it is determined whether the outside air is safe to introduce. If NO, the process proceeds to block 750. If YES, the block proceeds to block 770. It is noted that a minimum level of fresh air must be provided regardless due to code. Thus, outside air must remain at a minimum rate.

At block 750, if the outside air is not safe to introduce, a fan speed of the inside air intake is increased. The outside air may not be safe if, e.g., there is a fire in the area and smoke from the fire engulfed the entire area. In such circumstance, outside air should not be fed into the system. Instead, the system can reuse fresh air within the home.

At block 760, the measured values can be displayed and a time frame may be presented to the user for adjustment of air irregularities.

At block 770, if the outside air is safe (clean, fresh), the fan speed of the fan positioned in the intake channel is increased to introduce further fresh air from the outside.

At block 780, the one or more variables that exceeded their respective thresholds are displayed, on a display device, the measured values are provided, and a time frame for adjustment for each of the one or more variables that exceeded their respective thresholds is presented.

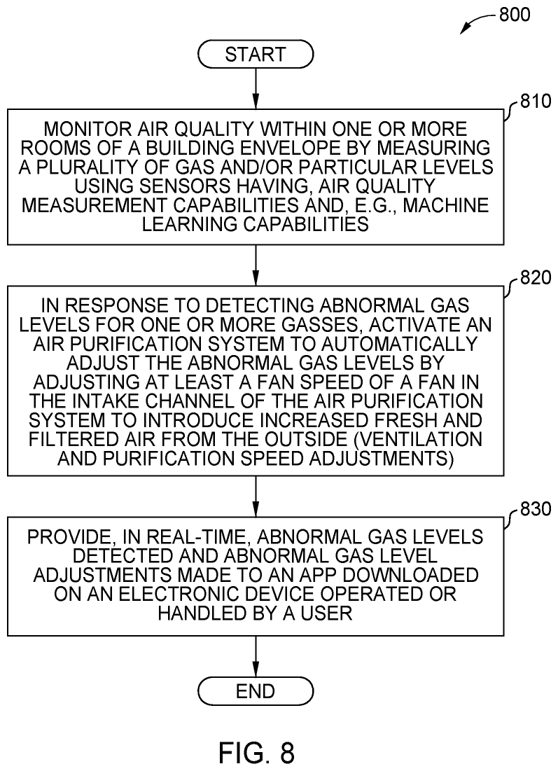

FIG. 8 illustrates a third sensor scenario 800, according to an example.

At block 810, air quality within one or more rooms of a building envelope is monitored by measuring a plurality of gas and/or particulate levels using sensors having air quality measurement capabilities and, e.g., machine learning capabilities. The sensors can detect at least particulate matter (PM), VOC, CO₂, CO, radon, natural gas, and other foreign gasses in a room and at the fresh air source while additionally monitoring air pressure.

At block 820, in response to detecting abnormal gas levels for one or more gasses, an air purification system is activated to automatically adjust the abnormal gas levels by adjusting at least a fan speed of a fan in the intake channel of the air purification system to introduce increased fresh and filtered air from the outside (ventilation and purification speed adjustments).

At block 830, abnormal gas levels detected in real-time are provided and abnormal gas level adjustments are made to an app downloaded on an electronic device or computing device operated or handled by a user. As such, the user is provided with the air improvement data in real-time. For example, if the CO₂ within a room of the house increased to 1250 ppm (exceeding the threshold of, e.g., 600 ppm), the user will be notified on the app with a time of the abnormal detection, a time when the first fan 212 was activated in response to that abnormal detection, a new speed of the first fan 212, a time it takes to adjust the CO₂ to less than 600 μm, and a progress report showing how the CO₂ is being reduced in real-time as more fresh air is entering the affected room. As such, the air quality score provided to the user is progressively adjusted in real-time to indicate to the user that the air quality is improving. In other words, air quality improvement metrics are constantly and continuously provided to the user in real-time so that the user can assess or evaluate the improvement in real-time (as the speeds of the first fan 212 and the second fan 214 are operating at their adjusted settings).

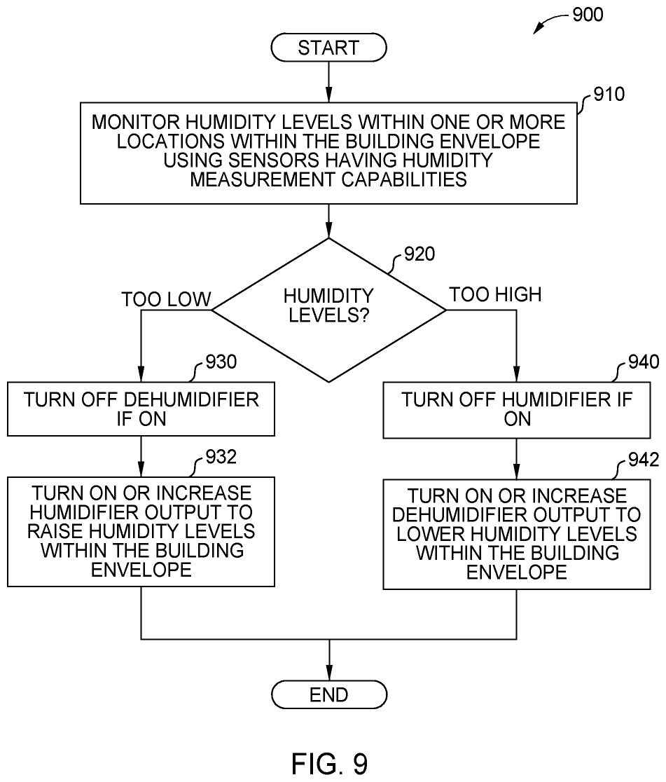

FIG. 9 illustrates a fourth sensor scenario 900, according to an example.

At block 910, humidity levels within one or more locations within the building envelope are monitored using sensors having humidity measurement capabilities.

At block 920, it is determined whether the humidity levels are too high or too low. If the humidity levels are too low, the process proceeds to block 930. If the humidity levels are too high, the process proceeds to block 940.

At block 930, when the humidity levels are too low, if the dehumidifier is ON, then the dehumidifier is turned OFF.

At block 932, the humidifier output is turned ON or increased to raise the humidity levels within the building envelope.

At block 940, when the humidity levels are too high, if the humidifier is ON, then the humidifier is turned OFF.

At block 942, the dehumidifier output is turned ON or increased to lower humidity levels within the building envelope.

In one example, the sensors can be artificial intelligence (AI) sensors. The AI sensors can employ machine learning (ML) techniques to collect data. ML refers to a system's ability to acquire and integrate knowledge through large-scale observations and to improve and extend itself by learning new knowledge rather than by being programmed with that knowledge. ML can employ ML algorithms to collect data related to at least air pressure, temperature, humidity, CO₂, CO, Rn, natural gas, NO₂, SO₂, C₆H₆, VOCs, PAH readings, and particulate readings. The AI/ML algorithms can be trained to detect any type of substances and/or pollutants, and are not limited to being trained to detect only the substances mentioned herein.

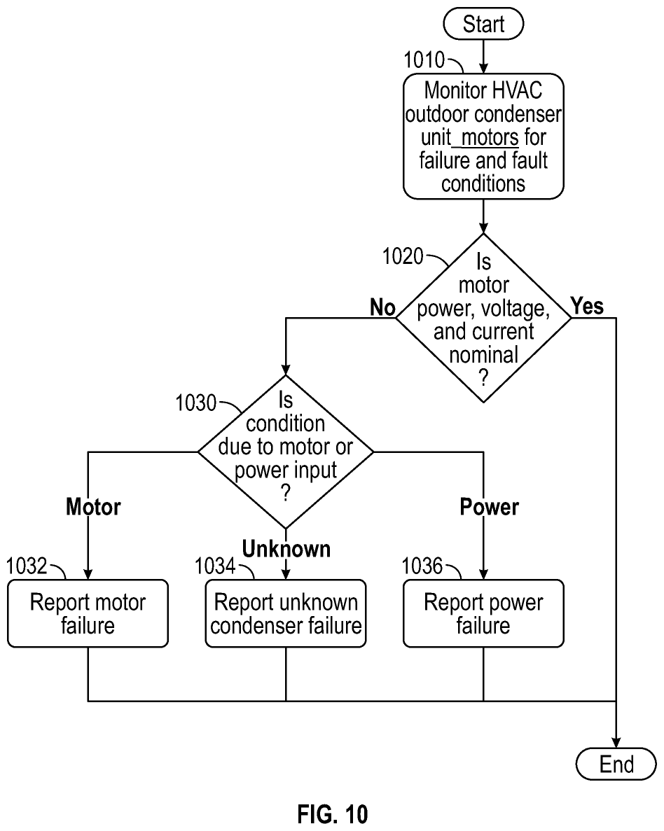

FIG. 10 illustrates a scenario for performing remote diagnostics of an existing or new outdoor HVAC condenser unit's motors and motor power supply lines and reporting the unit's operational status, according to an example.

At block 1010, the HVAC outdoor condenser unit motors are monitored for failure and fault conditions.

At block 1020, it is determined whether the motor power, voltage, and current are nominal. If YES, the process ends. If NO, the process proceeds to block 1030.

At block 1030, it is determined whether the condition is due to a motor input or a power input. If it is a motor input issue, the process proceeds to block 1032. If it is an unknown issue, the process proceeds to block 1034. If it is a power issue, the process proceeds to block 1036.

At block 1032, when a motor input issue is determined, the motor failure is reported.

At block 1034, when an unknown issue is determined, the unknown condenser failure is reported.

At block 1036, when a power input issue is determined, the power failure issue is reported.

A voltage and current sensor are placed on one or more electrical lines supplying power to the unit's compressor motor and/or blower motor. These sensors measure voltage and current, respectively, applied to the motor's power input. From these measurements, the health or operational status of the motor and/or supply lines can be determined, including whether the motor has failed electrically (open or short), whether the motor is blocked (prevented from rotating), or whether the supply lines are not supplying current power levels (indicated via abnormal voltage and/or current). A controller (e.g., microcontroller, single board computer, microprocessor or other similar control circuitry) directs the sensors to take readings and sends status reports to the main control via wired or wireless connection. When a fault or failure condition is detected, the system will send an alert to the main control unit via this connection.

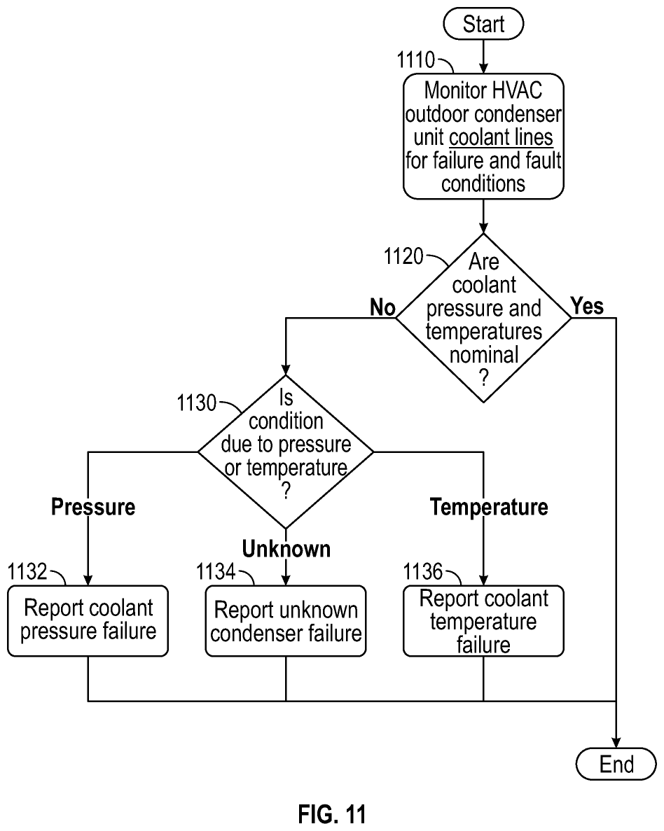

FIG. 11 illustrates a scenario for performing remote diagnostics of an existing or new outdoor HVAC condenser unit's coolant lines and reporting the unit's operational status, according to an example.

At block 1110, the HVAC outdoor condenser unit coolant lines are monitored for failure and fault conditions.

At block 1120, it is determined whether the coolant pressure and temperatures are nominal. If YES, the process ends. If NO, the process proceeds to block 1130.

At block 1130, it is determined whether the condition is due to a pressure issue or a temperature issue. If it is a pressure issue, the process proceeds to block 1132. If it is an unknown issue, the process proceeds to block 1134. If it is a temperature issue, the process proceeds to block 1136.

At block 1132, when a pressure input issue is determined, the coolant pressure failure is reported.

At block 1134, when an unknown issue is determined, the unknown condenser failure is reported.

At block 1136, when a temperature issue is determined, the coolant temperature failure issue is reported.

A pressure and temperature sensor are placed on one or more coolant lines connected to the external HVAC unit. These sensors measure the pressure and temperature, respectively, in the coolant lines to identify the operational status of the lines, including whether the coolant pressure is too high or too low, or whether the coolant is too hot or too cold. A controller directs the sensors to take readings and sends status reports to the main control unit via wired or wireless connection. When a fault or failure condition is detected, the system will send an alert to the main control unit via this connection.

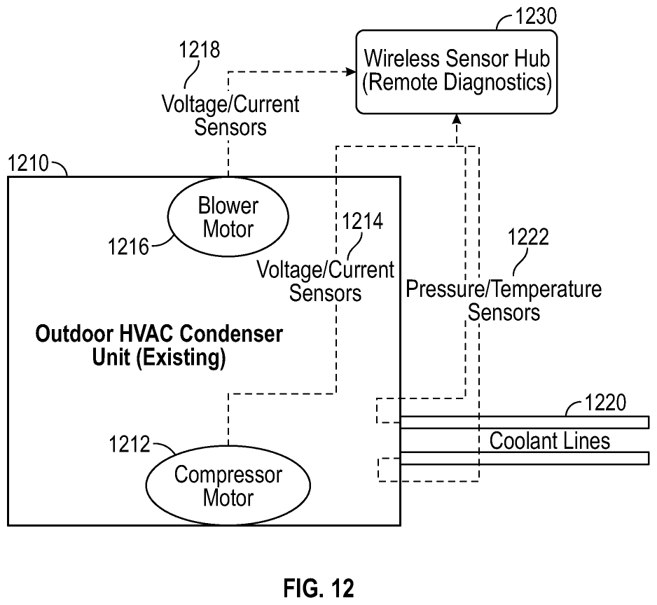

FIG. 12 illustrates a notional configuration for remote diagnostics of an existing or new outdoor HVAC condenser unit, as well as a wireless sensor hub that comprises a controller, and wireless or wired connectivity, according to an example.

The outdoor HVAC condenser unit 1210 includes a compressor motor 1212 communicating with voltage/current sensors 1214. The outdoor HVAC condenser unit 1210 further includes a blower motor 1216 communicating with voltage/current sensors 1218. The outdoor HVAC condenser unit 1210 communicates with coolant lines 1220 having pressure/temperature sensors 1222. The data from all the sensors is provided to a wireless sensor hub 1230.

One or more voltage and current sensors are connected to the sensor hub 1230 and physically placed for measurement of voltage and current, respectively, of the condenser motors' power supply lines. In addition, one or more pressure and temperature sensors 1222 are connected to the sensor hub 1230 and physically placed for measurement of pressure and temperature, respectively, on the condenser's coolant lines 1220. The pressure and temperature sensors 1222 may be favorably placed at the end of the coolant lines 1220, at the line's connection to the condenser unit 1210, or alternatively at another preferred location along the length of the coolant lines 1220.

In conclusion, toxins in indoor air, including mold, dust, pollen, viruses, bacteria, and toxic chemicals from cleaners and off-gassing, make up dangerous particulate matter (PM). Dangerous PM combined with lack of oxygen and too much carbon dioxide in indoor air, exacerbate the risk of heart disease and other ailments, and is a central cause of lower respiratory disease. The centers for disease control and prevention (CDC) recommend increasing ventilation to 5 air changes per hour (ACH) from 2 ACH. The average home has less than 0.5 CH due to insufficient access to air, which is 10× less than recommended by CDC. In accordance thereof, an inline system is presented that incorporates or integrates an air purification system with an HVAC system that, in response to detecting an adverse air quality event within the building envelope by a first sensor and a second sensor, automatically adjusts a speed of a first fan and a speed of a second fan (i) to maintain an air flow ratio between air inflow and air outflow within the HVAC system to ensure air pressure within the building envelope is balanced, (ii) to introduce increased fresh and filtered air flow from outside the structure, and (iii) to increase filtration of indoor air. The inline system conserves and optimizes energy through use while exceeding the CDC's current ventilation guidance, meeting and/or exceeding state ventilation code, purifying and detoxifying the air with one easy-to-install device. The air purification system is integrated with the HVAC system providing pre-conditioned ventilation and purification with optional scent infusion.

The benefits or advantages of using the inline system described herein relate to at least better quality and longer life, as purified air within a home can lessen chronic illnesses, lessen respiratory diseases, enable better concentration, better sleep, more energy, and lessen instances of depression and anxiety. Breathing better air quality can deter skin aging, vision irritation, and allergies, can deter asthma symptoms, emphysema, and bronchitis, can improve diabetes symptoms by curbing resistance to insulin, can deter blood clots, mitigate depression, anxiety, and dementia, and enhance reproductive health. As such, better ventilation can result in higher cognitive performance, and better overall health for occupants of a home.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product.

Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Such software and/or hardware embodiments can incorporate any type of machine learning process employing a variety of different types of training data. Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EEPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A method comprising:
using one or more first air quality sensors and an air purifier to detect and adjust air quality within a building envelope having a heating, ventilation, and air conditioning (HVAC) system, the air purifier having a first variable speed fan in an intake channel and a second variable speed fan in an exhaust channel; and
in response to detecting an adverse air quality event within the building envelope by one or more second air quality sensors, and measuring a difference in pressure between inside and outside the building envelope by one or more pressure or differential pressure sensors, and automatically adjusting a speed of the first variable speed fan and a speed of the second variable speed fan (i) to maintain an air flow ratio between air inflow and air outflow within the HVAC system to ensure air pressure within the building envelope is balanced, (ii) to introduce increased fresh and filtered air flow from outside the building envelope, and (iii) to increase filtration of indoor air.

2. The method of claim 1, wherein the adverse air quality event is triggered when one or more variables exceed a predetermined threshold.

3. The method of claim 1, wherein an air pressure balance within the building envelope is measured by a differential pressure sensor comprised of two pressures ports, where one pressure port is connected to the indoor air and the other pressure port is connected to outdoor air.

4. The method of claim 1, wherein one or more of the first air quality sensors measure indoor air quality and the one or more of the second air quality sensors measure outdoor air quality.

5. The method of claim 2, wherein the one or more variables are selected from the group consisting of air pressure, temperature, humidity, carbon dioxide (CO₂), carbon monoxide (CO), radon (Rn), natural gas, nitrogen dioxide (NO₂), sulfur dioxide (SO₂), benzene (C₆H₆), volatile organic compound (VOC), Polycyclic Aromatic Hydrocarbons (PAH) readings, and particulate readings.

6. The method of claim 1, further comprising incorporating an energy recovery ventilator (ERV), an ionization filter, and an Ultraviolet-C (UVC) light within the air purifier.

7. The method of claim 1, further comprising integrating the air purifier with the HVAC system having a return duct and a supply duct.

8. The method of claim 7, further comprising positioning the air purifier directly between the return duct and the HVAC system or plugged into the return duct.

9. The method of claim 7, further comprising connecting the one or more second air quality sensors to the return duct and the one or more second air quality sensors to the supply duct.

10. The method of claim 7, further comprising connecting the one or more second air quality sensors to the main system controller or to one or more thermostats cooperating with the HVAC system within the building envelope.

11. The method of claim 1, further comprising connecting the first and second sensors to a controller, wherein the controller controls the speeds of the first and second variable speed fans.

12. The method of claim 1, wherein the first variable speed fan is independently operable with respect to the second variable speed fan.

13. The method of claim 1, wherein the speed of the first variable speed fan is different than the speed of the second variable speed fan.

14. The method of claim 1, further comprising notifying a user of the adverse air quality event by sending a notification and an air quality report to a computing device handled or operated by the user.

15. The method of claim 1, wherein the air purifier includes a housing configured to couple the intake channel and the exhaust channel thereto.

16. The method of claim 15, wherein the intake channel receives fresh air flow from outside the building envelope and the exhaust channel passes stale air outside the building envelope.

17. The method of claim 16, wherein the fresh air flow received from the intake channel passes through an ERV and a portion of the stale air, received from a return duct of an HVAC system communicating with the air purifier, passes through the ERV.

18. A method for purifying air within a structure, the method comprising:
detecting negative air pressure balance within the structure's building envelope by one or more pressure and/or differential pressure sensors and using an air purifier having a first variable speed fan in an intake channel and a second variable speed fan in an exhaust channel; and
introducing increased fresh air flow from outside the building envelope by automatically adjusting a speed of the first variable speed fan.

19. The method of claim 18, wherein an air flow ratio is maintained between air inflow and air outflow within a heating, ventilation, and air conditioning (HVAC) system to ensure air pressure within the building envelope is balanced.

20. The method of claim 18, wherein one or more air quality variables within the building envelope are measured, the one or more air quality variables are selected from the group consisting of air pressure, temperature, humidity, carbon dioxide (CO₂), carbon monoxide (CO), radon (Rn), natural gas, nitrogen dioxide (NO₂), sulfur dioxide (SO₂), benzene (C₆H₆), volatile organic compound (VOC), Polycyclic Aromatic Hydrocarbons (PAH) readings, and particulate readings.

21. The method of claim 20, wherein a notification is triggered when the one or more air quality variables exceed respective predetermined thresholds.

22. The method of claim 18, further comprising integrating the air purifier with an HVAC system having a return duct and a supply duct.

23. The method of claim 22, further comprising positioning the air purifier directly between the return duct and the HVAC system.

24. The method of claim 23, wherein the negative air pressure is detected by a differential pressure sensor with two ports, wherein a first port is connected to an ambient room pressure and a second port is connected to a fresh air intake duct.

25. The method of claim 24, further comprising connecting the differential pressure sensor to a controller, wherein the controller controls a ratio of speeds of the first and second variable speed fans in order to maintain a desired pressure balance within the building envelope.

26. The method of claim 24, further comprising connecting one or more air quality sensors to a controller, wherein the controller controls the speed of both the first and second variable speed fans, while maintaining a ratio determined as a result of the differential pressure sensors.

27. The method of claim 18, wherein the first variable speed fan is independently operable with respect to the second variable speed fan.

28. The method of claim 18, wherein the speed of the first variable speed fan is different than a speed of the second variable speed fan.

29. The method of claim 18, further comprising notifying a user of the negative air pressure by sending a notification and an air quality report to a computing device handled or operated by the user.

30. An air purification system for a building, the air purification system comprising:
a housing including at least an energy recovery ventilator (ERV), an ionization filter, and a Ultraviolet-C (UVC) light;
an intake channel connected to the housing, wherein a first variable speed fan is located in an intake path; and
an exhaust channel connected to the housing, wherein a second variable speed fan is located in an exhaust path,
wherein, when an adverse air quality event is detected within the building, a speed of the first variable speed fan is automatically adjusted by a controller (i) to maintain an air flow ratio between air inflow and air outflow within a heating, ventilation, and air conditioning (HVAC) system to ensure air pressure within the building is balanced, (ii) to introduce increased fresh and filtered air flow from outside the building, and (iii) to increase filtration of indoor air.

31. The air purification system of claim 30, wherein the air purification system is integrated with the HVAC system having a return duct and a supply duct such that the air purification system is positioned directly between the return duct and the HVAC system.

32. A method for performing remote diagnostics of an HVAC condenser unit, the method comprising:
determining an operational status of the HVAC condenser unit; and
reporting the operational status to a user.

33. The method of claim 32, wherein the remote diagnostics are performed via an outdoor remote sensor hub comprising:
a housing including a controller, wireless or wired connectivity to a main control unit inside the building or other receiving unit, one or more voltage and current sensors for measuring the operational status of the condenser unit's compressor motor, blower motor, power supply lines, and one or more pressure and temperature sensors for measuring the operational status of the HVAC condenser unit's coolant lines.

34. The method of claim 33, further comprising notifying the user of healthy operational status or a fault or failure condition detected within the HVAC condenser unit, the electrical supply lines or the coolant lines.

35. The method of claim 34, further comprising notifying the user of a specific diagnosis and potential cause of the fault or failure condition.
